(19) United States
(12) Patent Application Publication
(10) Pub. No.: US 2021/0034621 A1
(43) Pub. Date: Feb. 4, 2021

(54) SYSTEM AND METHOD FOR CREATING DATABASE QUERY FROM USER SEARCH QUERY

(71) Applicant: Innoplexus AG, Eschborn (DE)

(72) Inventors: Sunil Patel, Dhinoj (IN); Ashwin Rathod, Hardap (IN)

(21) Appl. No.: 16/526,080

(22) Filed: Jul. 30, 2019

(51) Int. Cl. G06F 16/2452; G06F 17/27; G06N 20/00

(52) U.S. Cl. CPC G06F 16/24522; G06N 20/00; G06F 17/278

(57) ABSTRACT

Disclosed is system for creating database query from user search query. The system comprises computing device for receiving user search query. The system further comprises processing arrangement communicably coupled to computing device. The processing arrangement comprises query component parser for identifying one or more attributes of user search query. The processing arrangement further comprises one or more component resolution modules. The one or more component resolution modules is operable to receive one or more attributes of user search query; convert user search query into sentence vector; trigger, based on one or more attributes, at least one module from a set of modules; provide sentence vector to triggered at least one module; and receive output from triggered at least one module to obtain database query. Disclosed further is method for creating database query from user search query using aforementioned system.

### TECHNICAL FIELD

The present disclosure relates generally to natural language processing; and more specifically, to systems for creating database query from user search query. Moreover, the present disclosure relates to methods for creating database query from user search query. Furthermore, the present disclosure also relates to computer program products comprising non-transitory computer-readable storage media having computer-readable instructions stored thereon, the computer-readable instructions being executable by a computerized device comprising processing hardware to execute aforementioned methods.

### BACKGROUND

With the advancement in technology sector, various platforms, such as printed media, digital media and the like, have emerged for providing content required for carrying out any research work. Amongst these, digital media, especially internet, has gained immense popularity as an information source with easy accessibility. The internet may store data records of many years in an organized manner into databases, such as a relational database, an object-oriented database or a combination thereof, namely an object relational database.

Generally, the database is associated with a processing arrangement that allows a user to enter a search query to obtain data records stored in the database that are relevant to the search query. Typically, the search query provided by the user has to be based on the format in which data is stored in the database and in a syntax required by the processing arrangement to yield relevant data. Therefore, the user has to acquire a comprehensive knowledge of the format of the data stored in the database and also, the required syntax to obtain data records that are relevant thereto. Consequently, a user without the understanding of such formats and syntax, may not be able to create an efficient search query thus substantially limiting the scope of the search.

Furthermore, the existing techniques employed by conventional search engines to retrieve data records from databases merely match keywords in the search query with keywords in the data records and provide the user with data records comprising keywords matching to the search query. Such techniques fail to understand a context of a certain keyword in the search query, and relationship of such keyword with other keywords in the query and with prior search queries. Therefore, the existing techniques require frequent human intervention and additional time in order to modify, specifically refine, the search query to obtain data records most relevant to the user.

Therefore, in light of the foregoing discussion, there exists a need to overcome the aforementioned drawbacks associated with the existing techniques of database query generation.

### SUMMARY

The present disclosure seeks to provide a system for creating database query from user search query. The present disclosure also seeks to provide a method for creating database query from user search query. The present disclosure seeks to provide a solution to the existing problem of requirement of a predefined syntax of a search query to obtain data records relevant to a user. An aim of the present disclosure is to provide a solution that overcomes at least partially the problems encountered in prior art, and provides an improved and efficient system for creating database query from queries provided by the user in a natural language format.

In one aspect, an embodiment of the present disclosure provides a system for creating database query from user search query, wherein the system comprising
a computing device for receiving the user search query; and
a processing arrangement communicably coupled to the computing device, wherein the processing arrangement comprises
   a query component parser for identifying one or more attributes of the user search query; and
   one or more component resolution modules operable to
      receive the one or more attributes of the user search query;
      convert the user search query into a sentence vector;
      trigger, based on the one or more attributes of the user search query, at least one module from a set of modules comprising: topics module, target area module, filters module, search order module;
      provide the sentence vector to the triggered at least one module from the set of modules; and
      receive an output from the triggered at least one module to obtain the database query.

In another aspect, an embodiment of the present disclosure provides a method for creating a database query from a user search query, wherein the method is implemented using a system comprising
a computing device; and
a processing arrangement communicably coupled to the computing device, wherein the processing arrangement comprises
   a query component parser; and
   one or more component resolution modules;
      wherein the method comprises
receiving the user search query using the computing device;
identifying one or more attributes of the user search query using the query component parser;
receiving the one or more attributes of the user search query;
converting the user search query into a sentence vector;
triggering, based on the one or more attributes of the user search query, at least one module from a set of modules comprising: topics module, target area module, filters module, search order module;
providing the sentence vector to the triggered at least one module from the set of modules; and
receiving an output from the triggered at least one module to obtain the database query.

In yet another aspect, an embodiment of the present disclosure provides a computer program product comprising non-transitory computer-readable storage media having computer-readable instructions stored thereon, the computer-readable instructions being executable by a computerized device comprising processing hardware to execute an aforesaid method.

Embodiments of the present disclosure substantially eliminate or at least partially address the aforementioned problems in the prior art, and enables creating an efficient database query from a user search query without requiring frequent manual interventions for refining the user search query and increasing computational efforts and time required for retrieving most relevant search results.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a schematic illustration of a system for creating a database query from a user search query, in accordance with an embodiment of the present disclosure; and

FIG. 2 is a flow chart depicting steps of a method for creating a database query from a user search query, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In one aspect, an embodiment of the present disclosure provides a system for creating database query from user search query, wherein the system comprising
a computing device for receiving the user search query; and
a processing arrangement communicably coupled to the computing device, wherein the processing arrangement comprises
   a query component parser for identifying one or more attributes of the user search query; and
   one or more component resolution modules operable to
      receive the one or more attributes of the user search query;
      convert the user search query into a sentence vector;
      trigger, based on the one or more attributes of the user search query, at least one module from a set of modules comprising: topics module, target area module, filters module, search order module;
      provide the sentence vector to the triggered at least one module from the set of modules; and
      receive an output from the triggered at least one module to obtain the database query.

In another aspect, an embodiment of the present disclosure method for creating a database query from a user search query, wherein the method is implemented using a system comprising
a computing device; and
a processing arrangement communicably coupled to the computing device, wherein the processing arrangement comprises
   a query component parser; and
   one or more component resolution modules;
   wherein the method comprises
      receiving the user search query using the computing device;
      identifying one or more attributes of the user search query using the query component parser;
      receiving the one or more attributes of the user search query;
      converting the user search query into a sentence vector;
      triggering, based on the one or more attributes of the user search query, at least one module from a set of modules comprising: topics module, target area module, filters module, search order module;
      providing the sentence vector to the triggered at least one module from the set of modules; and
      receiving an output from the triggered at least one module to obtain the database query.

The aforesaid system for creating the database query from the user search query provides a platform that processes the user search query to derive search results therefor. Specifically, the system described herein identifies the one or more attributes of the user search query and further converts for example, a natural language (NL) user search query, into a database query in a machine-readable format. Beneficially, the database query removes the need of expertise to build an efficient query over indexing system and further enables retrieving most relevant data from a plurality of data sources. Moreover, the system enables retrieval of data in real-time and further processing thereof to obtain new suggestions related to the previous data to make the search more refined and results more relevant. Furthermore, the new suggestions are provided for visualization in an interactive manner for a prompt decision making. Additionally, the system substantially decreases human intervention and time required for retrieving data from the plurality of data sources and further provides the retrieved data in intelligible form. It will be appreciated that the aforementioned system proffers a platform to achieve a technical effect of building contextual queries, based on previous queries, that allow deeper insights into vast databases for generating most relevant results.

The system described herein, refers to a collection of one or more programmable and non-programmable components that are configured to create a database query from a user search query. In an example, the system may be a framework that is operable to perform end-to-end automation of receiving the user search query, processing the user search query, data extraction and providing result corresponding to the user search query. Throughout the present disclosure, the term “user” as used herein, refers to one or more individuals. For example, the user may include a researcher, a customer, a vendor, a physician and so forth. Furthermore, the user may be an amateur or an expert in a specific domain of the industry and requires data regarding a process or product related to the specific domain. Alternatively, the user may be a non-human apparatus, such as a bot or a software program implemented by way of a plurality of sub-routines, capable of querying a database.

Throughout the present disclosure, the term “user search query” relates to an input command provided by the user in order to extract information in the form of search results. Notably, the user search query is in a natural language format. Specifically, the user search query is provided in a text or a speech format comprising a word or a combination of one or more words to form the user search query. Additionally, the user search query indicates the specific field of interest of the user. Moreover, the extracted search results may have data related to the terms present in the user search query. Furthermore, the extracted search results may provide further understanding/insight into the field of interest of the user.

The system for creating database query from user search query comprises the computing device for receiving the user search query. Notably, the user search query may be provided using a user-interface of the computing device, such as a command prompt (or command line interface), a graphical user-interface and so forth. Throughout the present disclosure, the term “computing device” as used herein, refers to an electronic device associated with (or used by) the user that is capable of enabling the user to perform specific tasks associated with the aforementioned system. Furthermore, the computing device is intended to be broadly interpreted to include any electronic device that may be used for voice and/or data communication over a wired and/or wireless communication network. Examples of computing device include, but are not limited to, smart phones, personal digital assistants (PDAs), handheld devices, wireless modems, notebook or tablet computers, laptop computers, personal computers, home entertainment computers, interactive television, gaming system, a digital camera, and the like. Moreover, computing device may alternatively be referred to as a mobile station, a mobile terminal, a subscriber station, a remote station, a user terminal, a terminal, a subscriber unit, an access terminal, etc. Additionally, the computing device includes a casing, a memory, a processor, a network interface card, a microphone, a speaker, a keypad, and a display. Moreover, the computing device is to be construed broadly, so as to encompass variety of different types of mobile stations, subscriber stations or, more generally, communication devices, including examples such as combination of a data card inserted in a laptop; combination of a microphone inserted in a cellular phone and the like. Such computing devices are also intended to encompass devices commonly referred to as “access terminals”.

Optionally, the computing device is operable to receive the user search query as a text-based command or a speech-based command. The computing device receives the user search query on a user-interface rendered on the display screen thereof. Optionally, the user-interface is operable to interact with the user to receive input from the user in the form of the user search query via an input user-interface and convey graphical, and/or textual information corresponding to the user search query via an output user-interface. Examples of the input user-interfaces may include, but do not limit to, keyboard, mouse, trackball, stylus, touch screen, accelerometer, mic and so forth, where the input user-interface is capable of receiving speech-based command (i.e. by the mic) and text-based command (i.e. by the keyboard). Examples of the output user-interfaces include, but do not limit to, screen, speakers, tactile feedback, LEDs and so forth, where the output user-interface is capable of providing speech-based command converted into text-based command (i.e. by the screen). Additionally, the user-interface is generated by a set of instructions executable by the associated digital system.

Optionally, the computing device further comprises a speech-to-text converter. The speech-to-text converter comprises one or more programmable and non-programmable components for receiving audio inputs from the user and converting the received audio inputs into a corresponding text that is displayed by the display of the computing device. Specifically, speech-to-text converter includes a speech conversion program configured to convert the audio inputs into text. Optionally, the speech conversion program may be stored within or outside the computing device. Furthermore, the speech conversion program may use the speech pattern data to convert the audio input into text more accurately and/or efficiently in real-time.

Furthermore, the system comprises a processing arrangement communicably coupled to the computing device. The processing arrangement is communicably coupled, via a communication network, to the computing device. Throughout the present disclosure, the term “processing arrangement” refers to a computational element that is operable to respond to and process instructions that drive the system for creating the database query from the user search query. Optionally, the processing arrangement includes, but is not limited to, a microprocessor, a microcontroller, a complex instruction set computing (CISC) microprocessor, a reduced instruction set (RISC) microprocessor, a very long instruction word (VLIW) microprocessor, or any other type of processing circuit. Furthermore, the term ‘processing arrangement’ refers to one or more individual processors, processing devices and various elements associated with a processing device that may be shared by other processing devices. Additionally, the one or more individual processors, processing devices and elements are arranged in various architectures for responding to and processing the instructions that drive the system.

Furthermore, the processing arrangement is communicably coupled to the computing device, via the communication network. Throughout the present disclosure, the term “communication network” refers to an arrangement of interconnected programmable and/or non-programmable components that are configured to facilitate data communication between one or more electronic devices and/or databases, whether available or known at the time of filing or as later developed. Furthermore, the communication network includes, but is not limited to, one or more peer-to-peer network, a hybrid peer-to-peer network, local area networks (LANs), radio access networks (RANs), metropolitan area networks (MANS), wide area networks (WANs), all or a portion of a public network such as the global computer network known as the Internet, a private network, a cellular network and any other communication system or systems at one or more locations. Additionally, the communication network includes wired or wireless communication that can be carried out via any number of known protocols, including, but not limited to, Internet Protocol (IP), Wireless Access Protocol (WAP), Frame Relay, or Asynchronous Transfer Mode (ATM). In an example, the system employs Hyper Text Transfer Protocol (HTTP) for external communications over the communication network and Remote Procedure Call (RPC) such as google Remote Procedure Call (gRPC) for internal communications over the communication network.

Throughout the present disclosure, the term “database” as used herein, refers to an organized body of digital information regardless of the manner in which the data or the organized body thereof is represented. Furthermore, the term “database” refers to repositories where the data is stored in digital form that can be used for further computational process. Optionally, the database stores data in at least one of plurality of formats. Examples of the plurality of formats include, but are not limited to, textual data, audio data, visual data (namely, image, video, and so forth), spreadsheets, graphs, and scripts. Optionally, the database may be hardware, software, firmware and/or any combination thereof. For example, the organized body of related data may be in the form of a table, a map, a grid, a packet, a datagram, a file, a document, a list or in any other form. The database includes any data storage software and systems, such as, for example, a relational database like IBM DB2 and Oracle 9. In an example, the database may comprise a plurality of patent documents pertaining to a specific domain such as pharmaceuticals. In another example, the database may comprise a plurality of articles pertaining to a specific domain such as pharmaceuticals. Optionally, the database is implemented as a document database or wide column database (for example MongoDB, HBase and so forth) for data persistence and analytics. Additionally, optionally, the database is implemented as a search engine database (for example ElasticSearch and so forth) for instant information retrieval based on the user search query. Moreover, in an example, the database is implemented as a graph database (for example Neo4J, ArangoDB and so forth) to exploit concept relationships and empower discovery based on the user search query.

Moreover, optionally, the system acquires data from the at least one database based on the database query. Typically, the data from the at least one database refers to structured or unstructured data stored in the at least one database. Optionally, the user search query is inefficient and may not lead to relevant results. It will be appreciated that only an efficient query can generate most relevant results. In such case, the user search query received by the user is processed for utilization thereof. Specifically, the user search query is processed to obtain the database query that may be well understood by the database (namely, database query) and underlying search engine thereof, and subsequently provide relevant results therefrom. Specifically, converting the user search query comprises converting the user search query into a format using which the database can provide results relevant to the user. Beneficially, converting the user search query in the such format ensures a faster and efficient technique for obtaining the search results.

The processing arrangement comprises a query component parser for identifying one or more attributes of the user search query. The term “query component parser” refers to an analytical tool capable of parsing or resolving the user search query into its components, resulting in a parse hierarchical tree, showing their logical syntactic relationship with each other. The hierarchical parse tree represents one or more attributes. The term “one or more attributes” as used herein refers to one or more characteristic features of the user search query based on which the relevant search results are retrieved from the at least one database. Furthermore, the one or more attributes relate to the components in the user search query that provide the information relating to the requirements of the user with respect to the search results. Moreover, the query component parser provides information about the syntactic relationships between the various parts of the user search query and additional information about the each of such part. Notably, the query component parser is operable to divide the search query into individual components and determine the type of information such components seek to portray. In an example, the user search query may be, “find restaurants that serve Chinese cuisine”. Herein, the query component parser may analyze the user search query and based on the components ‘find’, ‘restaurants’, ‘serve’, and ‘Chinese cuisine’; the attributes related to the user search query are determined.

Optionally, the one or more attributes of the user search query include at least one of: a topic, one or more asset classes, one or more entity classes, one or more fields, a time frame, a name of an entity, an order of search, an inclusion, an exclusion, additional filter. More optionally, the term “topic” defines at least one of: a domain to be searched, a classification of the search query in the domain, a subject to be searched. The topic to be searched may comprise one or more words, such that topic composed of more than one word refers to one entity or a combination of two or more entities. The topic may include for example ‘breast cancer’, ‘EGFR’ and so forth. Moreover, the term “one or more asset classes” refers to property(s) of data sources or type of data on which the search is to be conducted. Beneficially, the one or more asset classes restrict the search to a specific type of data of the database. In an example, the asset class may include ‘publications’, ‘conferences’, ‘patents’ and so forth. In an example, the entity class may include ‘drugs’, ‘diseases’, ‘pathways’, ‘genes’ and the like. The term “one or more fields” define the specific sections of an asset class where a specific search may be conducted. The fields may include for example ‘title’, ‘abstract’, ‘IPC and/or CPC’, ‘publication number’, ‘author(s)’, ‘affiliation’, ‘keyword’, ‘date’ and so forth. The fields further restrict the search to a specific type of data. Moreover, the “name of an entity” refers to name of one or more individuals, company, geo-physical entities, technologies and so forth. The “order of search” defines one of the ways to present the most relevant information first. The user may specify the order with respect to the one or more attributes and/or field to be searched in, such as date, title, author, citation, and so forth. Moreover, the order of search may be provided explicitly describing the order of search as ascending or descending. The “inclusion” and “exclusion” define a criterion for restricting the search to a specific type of data. Beneficially, the inclusion-exclusion criteria avoid erroneous results due to polysemy and matching context. In an example, “EGFR” is a gene, a protein and a short form related to a kidney function, namely estimated glomerular filtration rate. In such case, use of the inclusion-exclusion criteria to include results from gene and exclude results related to kidney can provide relevant results specific for gene study based on EGFR. Optionally, the inclusion-exclusion queries may be based on a nested search. The term “nested” refers to a building of new queries on top of the previous queries, such that the previous queries are preserved, and additional queries are generated on the results generated using the previous queries, such that the second entity is again fed to the network and in a recursive manner the output is generated. Beneficially, nested search allows drilling down and thus generating better analytical options for generating relevant results. Additionally, the nested search allows generating a detailed interactive plot in the visualization phase. The “additional filter” may be applied to obtain results for example for ‘a particular country’ (namely, a geological entity), ‘a particular inventor’, ‘a particular domain’ (such as biology), and so forth, and any combinations thereof. Further, logical operators, such as AND. OR and/or NOT may be used.

More optionally, the term “time frame” defines a specified period of time, wherein the data records added in that specified time period are to be retrieved. Moreover, the time frame can be given in various ways. In an example, the time frame may be provided in a non-specific way, such as ‘recent’, in past and so forth, making it unclear if the search is to be conducted for past one hour, or past one year or a decade. In another example, the time frame may be provided in a time step ranging from that time step till the present date, such as ‘recent 5 years’. In yet another example, the time frame may be explicitly specified, such as by providing two dates describing a start and an end time frame of interest for the search, for instance, ‘between Jul. 13 and Aug. 15, 2018’. Optionally, the processing arrangement further comprises a dense layer parser for parsing a textual date into a timestamp. It will be appreciated that with the various ways in which time frame may be provided, rule-based business decisions may be prone to error. Therefore, a dense layer parsing may be used, following a single-layered recurrent neural network (RNN), such as LSTM or GRU, to parse the textual date into the timestamp, namely Unix timestamp. The term “timestamp” refers to the number of seconds that have elapsed since Jan. 1, 1970 (midnight UTC/GMT), i.e. Unix time 0 (midnight Jan. 1, 1970).

In an example, the user search query “Find me articles titles related to TNBC and breast cancer within past 3 years in ascending order of publication date written by Pompeo Pepe aggregate results by ids” can be broken into individual words or components such as ‘Find’, ‘articles’, ‘breast cancer’ ‘before’ and ‘2009’. In the above example, ‘Find’, ‘articles’, ‘titles, ‘TNBC and breast cancer’ ‘within past 3 years’, ‘ascending order’ ‘publication date’, ‘Pompeo Pepe’, and ‘aggregate results by ids’ represent one or more attributes, namely a command, an asset class, a field, topics, an inclusion, an order of search based on a time frame, an order of search based on a field, and aggregation of data based on a field, respectively. The term “aggregation” as used herein refers to compiling results obtained from searching across various fields. Thus, the user search query is segmented into query components based on the ontology and by identifying semantic associations between the one or more query components, and further the one or more query components are associated with one or more attributes. Beneficially, tagging the one or more query components associated with the one or more attributes provides a more organized, assembled and manageable form of the user search query. Consequently, tagging provides an easier understanding of contextual (namely, inferred) meaning of the one or more query components of the user search query. Beneficially, the association of the one or more query components provides wider understanding regarding the inferred meaning of the user search query.

Moreover, the one or more attributes may have one or more meaning that therefore can be used as one or more part of speech in the user search query. The one or more attributes of the successful parse are matched to the database names in the database and the results are provided to the user to select the correct parse. Alternatively, a heuristic approach may be adopted by the processor to select the correct parse. Moreover, identified components that are not recognized by the query component parser, for example a misspelling, may not be parsed, leading to a no parse case, and the user is asked to check the user search query or provide a new user search query.

Optionally, the query component parser employs a deep learning-based algorithm trained in a supervised manner to parse the user search query. More optionally, the query component parser takes forward the previous arguments and builds a new argument based thereon and returns modified results. In such case, the one or more attributes are identified by the query component parser and a downward call is made to specific component parsers.

Further, the processing arrangement comprises one or more component resolution modules. The term “one or more component resolution modules” as used throughout the present disclosure refers to analytical tools for parsing data related to one or more attributes. In this case, the one or more attributes are converted into a form recognized by the component resolution module. The one or more component resolution modules is operable to receive the one or more attributes of the user search query from the query component parser. Further, the one or more component resolution modules are operable to convert the user search query into a sentence vector. Optionally, the one or more component resolution model is operable to convert the user search query, based on the identified one or more attributes associated with the query components, in to the corresponding sentence vectors. More optionally, a bidirectional RNN may be applied on the user search query to convert the user search query into the sentence vector. The sentence vector contains entire information of the user search query in an n-dimensional array. The information comprised in the sentence vector includes, but is not limited to, a topic, one or more asset classes, one or more fields, a time frame, a name of an entity, an order of search, an inclusion, an exclusion, additional filter. The sentence vector may use available state of the art techniques like Skip-thought and Infersent. The one or more component resolution module comprises a set of modules comprising: topics module, target area module, filters module and search order module.

The term “sentence vector” refers to a location of the search query by way of a set of numbers, letters, symbols, or a combination thereof in the multi-dimensional hierarchical space. Specifically, the one or component resolution modules are operable to obtain the sentence vector by analysing token coordinates (wherein, token represents each word in the user search query) relating to the user search query.

In an embodiment, the one or more component resolution modules may compute a resultant coordinate from the token coordinates of tokens (namely, words in the user search query) so as to determine the sentence vector for the user search query. In an example, the resultant coordinate may be a mean of the token coordinates of tokens in the user search query in Euclidean cartesian form. In another example, the resultant coordinate of the token may be a cosine product (namely, dot product) of the token coordinates of tokens in the user search query in vector form.

Typically, the term “tokenize” refers to a process of breaking a sequence of strings into smaller entities. Additionally, the entities defined may be words, keywords, phrases, symbols, and so forth. The process of tokenization is performed by a one or more components resolution modules. Optionally, the one or more components resolution modules identifies tokens based on at least one of: rules pertaining to lexeme, regular expressions, specific sequence of characters of one or more words, specific and separating characters (such as, punctuations, white spaces, and so forth). More optionally, tokens may be made of alphabetic characters, alpha-numeric characters, or numeric characters. In an embodiment, the one or more components resolution modules analyzes a punctuation character (such as, a period ‘.’) and white space so as to define tokens. In such case, the punctuation character (namely, the period ‘.’) may denote an abbreviation, a decimal point, an ellipsis, an email-address, or an end of a sentence. In an example, for a sentence, ‘Mr. Smith is my neighbor.’, the tokenizer module may define the tokens to be ‘Mr. Smith’, ‘is’, ‘my’, ‘neighbor’, ‘.’.

Furthermore, it will be appreciated that the “tokens” identified by the tokenizer module refers to entities such as individual words, keywords, phrases, and so forth. Typically, obtaining the tokens for the user search query relies upon heuristic procedures. Moreover, in an example, the characters may be placed together with arithmetic operator, without white spaces, such that it appears as a single word. In such case, the arithmetic operator may be considered as a token. Furthermore, the arithmetic operator may be considered as a separator (such as, a white space).

The one or more component resolution modules is configured to determine token coordinates of each of the plurality of tokens in the multi-dimensional hierarchical space. Typically, the token coordinates refer to a location of an entity (namely, a token) in the multi-dimensional hierarchical space, wherein the location is specified by a set of numbers, letters, symbols, or a combination thereof.

The one or more component resolution modules is further operable to trigger, based on the one or more attributes of the user search query, at least one module from a set of modules comprising: topics module, target area module, filters module, search order module. Specifically, the query component parser assists the one or more component resolution modules to selectively trigger at least one module. It will be appreciated that of the set of modules, only those modules will be triggered the attributes related to which are identified by the query component parser while parsing and tagging the user search query into query components and extracting one or more attributes therefrom. The topics module refers module for identifying at least one of: a domain, a classification in the domain, a subject. Specifically, the topic module is triggered if the identified one or more attributes include a topic attribute in the user search query. The term “target area module” refer to the module for identifying different data sources and/or elements in the user search query required to restrict the search results to a specific type of data in the database. Furthermore, the filters module refers to the module for identifying specific filters that may be provided in the user search query by the user to limit scope of the search results retrieved. Example of the filters may include, but are not limited to, ‘a particular country’ (namely, a geological entity), ‘a particular inventor’, ‘a particular domain’ (such as biology), and so forth, and any combinations thereof. Moreover, the search order module is operable to identify from the user search query, an order of search specified by the user therein. The order of search may be, for example, in an ascending order of timestamps.

Optionally, the target area module comprises an asset class sub-module, an entity class sub-module, a field sub-module and an inclusion-exclusion sub-module. The target area module is triggered if the identified one or more attributes include any one of the target area related attributes in the user search query. The attributes related to target area may be at least one of: an entity class, an asset class, a field and an inclusion-exclusion, discussed in detail hereinafter. The asset class sub-module refers to a sub-module of the target area module that is operable to identify, in the user search query, one or more asset class as previously explained. The asset class sub-module is triggered if the identified one or more attributes include any one of the asset class related attributes in the user search query. The entity class sub-module refers to a sub-module of the target area module that is operable to identify, in the user search query, one or more entities classes described as above. The entity class sub-module is triggered if the identified one or more attributes include any one of the entity class in the user search query. The field sub-module refers to a sub-module of the target area module that is operable to identify, in the user search query, the specific sections within an asset class, as explained previously. The field sub-module is triggered if the identified one or more attributes include any one of the fields in the user search query. The inclusion-exclusion sub-module is operable to identify, in the user search query, a criterion for restricting the search to a specific type of data as explained previously. The inclusion-exclusion sub-module is triggered if the identified one or more attributes include any inclusion-exclusion in the user search query.

Optionally, the set of modules employ machine learning algorithms. Throughout the present disclosure, the term “machine learning algorithms” refer to a category of algorithms employed by a programmable and non-programmable components such as the set of modules. The machine learning algorithms allow the set of modules to become more accurate in predicting outcomes and/or performing tasks, without being explicitly programmed. Specifically, the machine learning algorithms are employed to artificially train the set of modules so as to enable them to automatically learn, from analyzing training dataset and improving performance from experience, without being explicitly programmed. Optionally, the set of modules, employing the machine learning algorithms, is trained using a training dataset. More optionally, the is operable to identify, in the user search query, may be trained using different types of machine learning algorithms, depending upon the training dataset employed. Typically, examples of the different types of machine learning algorithms, depending upon the training dataset employed for training the is operable to identify, in the user search query, comprise, but are not limited to: supervised machine learning algorithms, unsupervised machine learning algorithms, semi-supervised machine learning algorithms, and reinforcement machine learning algorithms. Furthermore, the software application is trained by interpreting patterns in the training dataset and adjusting the machine learning algorithms accordingly to get a desired output.

Optionally, the set of modules, employing machine learning algorithms, are trained using supervised learning techniques. Optionally, supervised learning techniques refer to a learning technique employed by the machine learning algorithms to train the set of modules using labeled training dataset or structured training information. Specifically, the training dataset employed for training the set of modules using supervised learning techniques is classified and labeled. More specifically, the supervised learning techniques employ supervised machine learning algorithms that are trained with a desired output. The supervised machine learning algorithms analyze the labeled training dataset provided for training and further interpret the training dataset so as to sort the training data using predefined labels.

Furthermore, optionally, examples for supervised machine learning algorithms employed for supervised learning of an inherent structure relating to the training dataset, using explicitly-provided labels include, but are not limited to: Logistic Regression, Linear Regression, K-nearest neighbors (K-NN), Support Vector Machine (SVM), Kernel SVM, Radial Basis Function (RBF) Kernel, Naïve Bayes, Linear Discriminant Analysis, Decision Trees, Ensemble Method, Similarity Learning and Neural Networks.

The one or more component resolution modules is further operable to provide the sentence vector to the triggered at least one module from the set of modules. It will be appreciated that the sentence vector is representation of the search query in a multi-dimensional space, wherein the sentence vector has been determined by taking into account various characteristics and properties associated with the search query such as context of the user search query. Furthermore, the one or more attributes of the user search query are represented by the sentence vector, wherein the triggered modules from the set of modules are operable to receive the sentence vector from the one or more component resolution module are determine at least one of the: topic, target area, filter, inclusion-exclusion. It will be appreciated that the query component parser is merely operable to determine the presence of a given attribute in the search query. For example, the query component parser may merely identify that the user search query comprises a topic and a target area, such as an asset class. However, the modules in the set of modules are operable to determine a type (namely, value) of such attribute. In an example, the user search query may be “Find articles related to breast cancer”. In such example, the query component parser may identify the presence of a topic and a target area (specifically, an asset class) in the given user query. Subsequently, the topics and the target area module may be triggered and the sentence vector for the user search query may be provided thereto. Consequently, the topics module may identify the topic as ‘breast cancer’ and the target area module may identify the target area for search as ‘articles’.

The one or more component resolution modules is further operable to receive an output from the triggered at least one module to obtain the database query. The triggered at least one module provides the output corresponding to the function thereof. For example, the output provided by the topics module is the value or type of the type provided in the user search query. Similarly, the output provided by the target area module may be the areas in the database that are to be targeted to perform the search. Subsequently, such outputs provided by the triggered at least one module are combined to obtain the database query that is used to retrieve search results from the database.

Optionally, the set of modules further comprises a dynamic query expansion module. The term “query expansion” refers to a process of generating a plurality of new search queries, namely sub-queries, based on the user search query. The term “dynamic query expansion module” refers to an analytical tool operable to improve the search results retrieval by recalling through an expansion of query or keywords of the user search query. The dynamic query expansion module provides suggested and/or expanded query terms associated with the query components. For example, one or more query components may be expanded to include plural and singular forms, synonyms, hypernyms and so forth, to ensure that data comprising the expanded terms are also retrieved in the search results. Specifically, the dynamic query expansion module comprises ontology synonyms lookup, asset wide search and reaching similar entities across domain. Typically, the query expansion is accomplished by searching in the plurality of databases and/or finding neighbors in an embedding space so that related data is accessed. In an example, the dynamic query expansion module may add more fields to the search. In another example, the dynamic query expansion module may add more asset classes in the search. In yet another example, the dynamic query expansion module may suggest related biological and geological entities. In the above example, the biological and geological entities are identified based on the embedding methods, whereby for the given entity's n-dimensional space its neighbors are identified. Optionally, the n-dimensional space may be made up of a vector size ranging from 50 to 1000, depending upon the complexity and variational nature of the concerned domain. Beneficially, inclusion of query expansion into query search results in an exhaustive search and yields better results compare to a simple query search.

Optionally, the dynamic query expansion module builds the sub-queries on previous queries or starts with a new query. More optionally, the dynamic query expansion module is based on a FNN with two outputs. In case the output is 0 then the query expansion is based on previous queries. If the output is 1 then the previous queries are purged and a new query building starts. Optionally, the dynamic query expansion module comprises a weighing component for weighing the suggested query expansion terms by comparing it with the query components in one or more databases, using any form of a semantic relatedness method.

Optionally, the system further comprises a memory module for storing data. The memory module may include, but is not limited to, a disc drive, a bulk storage apparatus and the like. Optionally, a system dictionary is stored in the memory module. More optionally, the memory module stores entire databases therein. Furthermore, optionally, the memory module stores the data, such as search results, in the at least one database. Subsequently, data stored in the at least one database is a set of indexed, organized and semantically associated information generated by the database query from a plurality of databases. Beneficially, the data stored in the at least one database enhances accessibility of data. Consequently, the system does not need to refer the plurality of databases for further processing and analysis of data in response to a similar database query.

Moreover, the present description also relates to the method as described above. The various embodiments and variants disclosed above apply mutatis mutandis to the method.

Optionally, the target area module comprises
an asset class sub-module;
an entity class sub-module;
a field sub-module; and
an inclusion-exclusion sub-module.

Optionally, the set of modules employ machine learning algorithms.

Optionally, the set of modules, employing machine learning algorithms, are trained using supervised learning techniques.

Optionally, the one or more attributes of the user search query include at least one of: a topic, one or more asset classes, one or more fields, a time frame, a name of an entity, an order of search, an inclusion, an exclusion, additional filter.

Optionally, the method further comprises receiving the user search query as a text-based command or a speech-based command.

Optionally, the set of modules further comprises a dynamic query expansion module.

Optionally, the method further comprises parsing a textual date into a timestamp.

In yet another aspect, an embodiment of the present disclosure relates to a computer program product comprising non-transitory computer-readable storage media having computer-readable instructions stored thereon, the computer-readable instructions being executable by a computerized device comprising processing hardware to execute a method for creating a database query from a user search query.

### DETAILED DESCRIPTION OF THE DRAWINGS

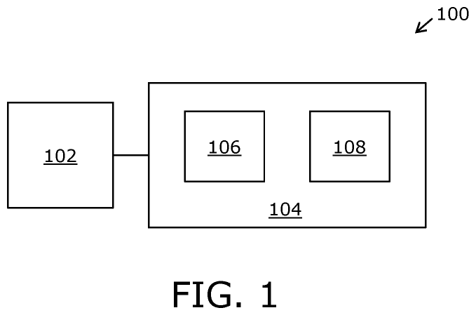

Referring to FIG. 1, there is shown a schematic illustration of a system 100 for creating a database query from a user search query, in accordance with an embodiment of the present disclosure. The system 100 comprises a computing device 102 and a processing arrangement 104 communicably coupled to the computing device 102. The computing device 102 is operable to receive the user search query. The processing arrangement 104 comprises a query component parser 106 for identifying one or more attributes of the user search query. The processing arrangement 104 further comprises one or more component resolution modules 108.

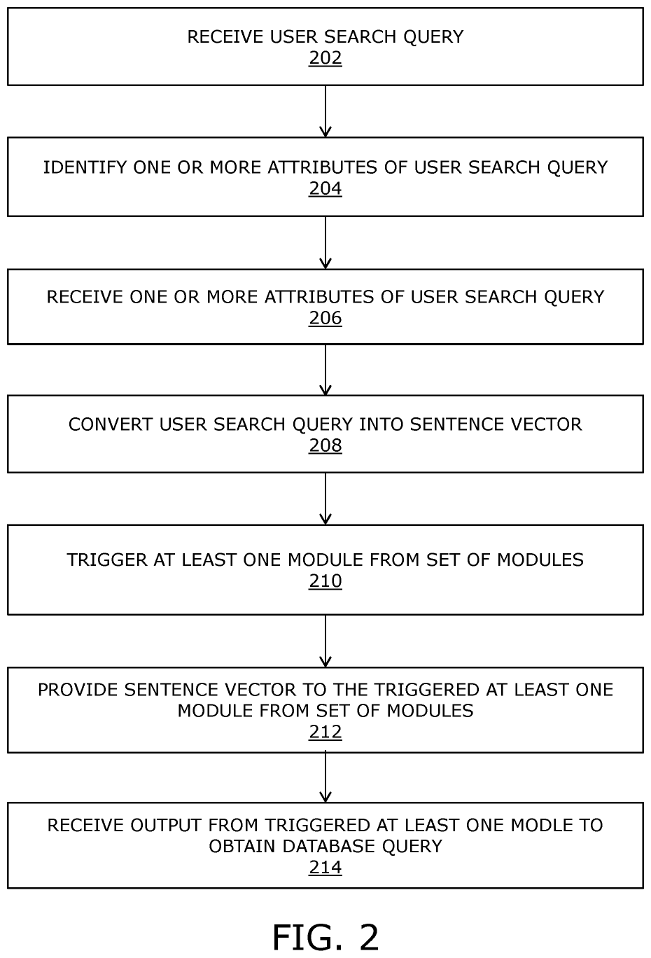

Referring to FIG. 2, there is shown a flow chart depicting steps of a method for creating a database query from a user search query, in accordance with an embodiment of the present disclosure. The method is depicted as a collection of steps in a logical flow diagram, which represents a sequence of steps that can be implemented in hardware, software, or a combination thereof, for example as aforementioned.

The method for creating the database query from the user search query is implemented via a system comprising a computing device and a processing arrangement communicably coupled to the computing device. The processing arrangement comprises a query component parser and one or more component resolution modules.

At a step 202, the user search query is received using the computing device. At a step 204, one or more attributes of the user search query is identified using the query component parser. At a step 206, one or more attributes of the user search query is received. At a step 208, the user search query is converted into a sentence vector. At a step 210, at least one module from a set of modules is triggered based on the one or more attributes of the user search query. At a step 212, the sentence vector is provided to the triggered at least one module from the set of modules. At a step 214, an output is received from the triggered at least one module to obtain the database query.

The steps 202 to 214 are only illustrative and other alternatives can also be provided where one or more steps are added, one or more steps are removed, or one or more steps are provided in a different sequence without departing from the scope of the claims herein.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

What is claimed is:

1. A system for creating a database query from a user search query, the system comprising
a computing device for receiving the user search query; and
a processing arrangement communicably coupled to the computing device, wherein the processing arrangement comprises
a query component parser for identifying one or more attributes of the user search query; and
one or more component resolution modules operable to
receive the one or more attributes of the user search query;
convert the user search query into a sentence vector;
trigger, based on the one or more attributes of the user search query, at least one module from a set of modules comprising: topics module, target area module, filters module, search order module;
provide the sentence vector to the triggered at least one module from the set of modules; and
receive an output from the triggered at least one module to obtain the database query.

2. The system of claim 1, wherein the target area module comprises
an asset class sub-module;
an entity class sub-module;
a field sub-module; and
an inclusion-exclusion sub-module.

3. The system of claim 1, wherein the set of modules employ machine learning algorithms.

4. The system of claim 3, wherein the set of modules, employing machine learning algorithms, are trained using supervised learning techniques.

5. The system according to claim 1, the one or more attributes of the user search query include at least one of: a topic, one or more asset classes, one or more entity classes, one or more fields, a time frame, a name of an entity, an order of search, an inclusion, an exclusion, additional filter.

6. The system according to claim 1, wherein the computing device is operable to receive the user search query as a text-based command or a speech-based command.

7. The system according to claim 6, wherein the computing device further comprises a speech-to-text converter.

8. The system according to claim 1, wherein the set of modules further comprises a dynamic query expansion module.

9. The system according to claim 1, wherein the processing arrangement further comprises a dense layer parser for parsing a textual date into a timestamp.

10. A method for creating a database query from a user search query, wherein the method is implemented using a system comprising
a computing device; and
a processing arrangement communicably coupled to the computing device, wherein the processing arrangement comprises
a query component parser; and
one or more component resolution modules;
wherein the method comprises
receiving the user search query using the computing device;
identifying one or more attributes of the user search query using the query component parser;
receiving the one or more attributes of the user search query;
converting the user search query into a sentence vector;
triggering, based on the one or more attributes of the user search query, at least one module from a set of modules comprising: topics module, target area module, filters module, search order module;
providing the sentence vector to the triggered at least one module from the set of modules; and
receiving an output from the triggered at least one module to obtain the database query.

11. The method of claim 10, wherein the target area module comprises
an asset class sub-module;
an entity class sub-module;
a field sub-module; and
an inclusion-exclusion sub-module.

12. The method of claim 1, wherein the set of modules employ machine learning algorithms.

13. The method of claim 12, wherein the set of modules, employing machine learning algorithms, are trained using supervised learning techniques.

14. The method according to claim 10, the one or more attributes of the user search query include at least one of: a topic, one or more asset classes, one or more entity classes, one or more fields, a time frame, a name of an entity, an order of search, an inclusion, an exclusion, additional filter.

15. The method according to claim 10, wherein the method further comprises receiving the user search query as a text-based command or a speech-based command.

16. The method according to claim 10, wherein the set of modules further comprises a dynamic query expansion module.

17. The method according to claim 10, wherein the method further comprises parsing a textual date into a timestamp.

18. A computer program product comprising non-transitory computer-readable storage media having computer-readable instructions stored thereon, the computer-readable instructions being executable by a computerized device comprising processing hardware to execute a method of claim 10.
